(19) United States
(12) Patent Application Publication
(10) Pub. No.: US 2024/0104993 A1
(43) Pub. Date: Mar. 28, 2024

(54) ARTICLE SUPPLY DEVICE AND ARTICLE SUPPLY DEVICE SET

(71) Applicant: BANDAI CO., LTD., Tokyo (JP)

(72) Inventors: Hajime KONDO, Tokyo (JP); Tatsushi IKARASHI, Tokyo (JP); Nobuo KUROKAWA, Tokyo (JP)

(21) Appl. No.: 18/468,704

(22) Filed: Sep. 16, 2023

(30) Foreign Application Priority Data
Sep. 26, 2022 (JP) 2022-152361

(51) Int. Cl. G07F 11/00

(52) U.S. Cl. CPC G07F 11/00

(57) ABSTRACT

An article supply device comprises a main body, a first type article accommodation unit or a second type article accommodation unit, an attachment unit capable of replacing the first type article accommodation unit and the second type article accommodation unit with each other, a first supply unit which supplies a first type article in the first type article accommodation unit, a first supply port formed in the main body, and, a second supply unit which includes a second supply port and supplies a second type article in the second type article accommodation unit, wherein the first supply unit supplies the first type article to the first supply port when the first type article accommodation unit is attached to the attachment unit, and the second supply unit supplies the second type article to the second supply port when the second type article accommodation unit is attached to the attachment unit.

### RELATED APPLICATION

The disclosure of Japanese Patent Application Nos. 2022-152361 (filed on Sep. 26, 2022) including specification, drawings and claims is incorporated herein by reference in its entirety.

### TECHNICAL FIELD

The present invention relates to an article supply device and an article supply device set.

### BACKGROUND

Patent Document 1 discloses an article supply device. The article supply device comprises a handle capable of performing a first handle operation from an initial position to a coin detection position, and a second handle operation after the first handle operation, which is capable of supplying an article according to payment of consideration; an article supply mechanism for supplying the article; a handle operation mechanism which allows the handle operations; a coin detection mechanism for detecting whether or not a coin(s) is inserted; a handle lock mechanism for preventing the second handle operation by an engaging portion when no coin is inserted; a handle lock releasing mechanism, which is configured to manually interlock with the handle and the engaging portion and to release the interlock, and which is operated with the second handle operation in the interlocked state and allows the second handle operation twice or more times when a coin(s) is inserted once.

### PRIOR ART

### Patent Documents

[Patent Document 1] Japanese Patent Application Publication No. 2019-207579

### SUMMARY

### Technical Problem

The article supply device disclosed in Patent Document 1 supplies spherical capsule shaped articles, each of which has the same form, and cannot supply any article other than the capsule shaped articles. That is, in this type of the article supply method, an article supply device dedicated to a certain form (appearance shape) article is required. When the other shape article is sold, another article supply device is required. As a result, a device having different mechanism is required for each type article. When various types of articles are sold, many types of devices are required.

It is an object of the present invention to provide a versatile article supply device and a versatile article supply device set, which can be used for supply of different articles.

### Solution to Problem

One of the aspects of the present invention is an article supply device. The article supply device comprises a main body; a first type article accommodation unit or a second type article accommodation unit, an attachment unit provided in the main body and capable of attaching and replacing the first type article accommodation unit and the second type article accommodation unit with each other; a first supply unit which supplies a first type article accommodated in the first type article accommodation unit; a first supply port formed in the main body; and a second supply unit which includes a second supply port and supplies a second type article accommodated in the second type article accommodation unit, wherein the first supply unit supplies the first type article to the first supply port in a state where the first type article accommodation unit is attached to the attachment unit, and the second supply unit supplies the second type article to the second supply port in a state where the second type article accommodation unit is attached to the attachment unit.

Another aspect of the present invention is an article supply device set which comprises a plurality of article supply devices. The article supply device set comprises first article supply devices, each capable of supplying a first type articles in a spherical shape, to each of which a first type article accommodation unit accommodating the first type articles is attached, and second article supply devices, each capable of supplying second type articles in a sheet shape, to each of which a second type article accommodation unit accommodating the second type article is attached, wherein the first article supply devices and the second article supply devices respectively have the same configuration so that either the first type article accommodation unit or the second type article accommodation unit can be attached to the main body of each of the first article supply devices and that of each of the second article supply devices.

### Advantageous Effect of Invention

According to the present invention, it is possible to provide a versatile article supply device and a versatile article supply device set capable of being used for supplying different articles. There are a number of advantages and there is no requirement that a claim be limited to encompass all of the advantages.

In addition, the foregoing has outlined rather broadly the features and technical advantages in order that the detailed description of the invention that follows may be better understood. Additional features and advantages will be described hereinafter which form the subject of the claims.

### BRIEF DESCRIPTION OF DRAWINGS

For a more complete understanding, and the advantages thereof, reference is now made to the following description taken in conjunction with the accompanying drawings, in which:

FIG. 1 is a perspective view of an external appearance of an article supply device capable of supplying a first type article;

FIG. 2 is a perspective view of an external appearance of an article supply device capable of supplying a second type article;

FIG. 3 is a schematic perspective view of the article supply device shown in FIGS. 1 and 2 in a state where a first type article accommodation unit and a second type article accommodation unit are detached from the main body;

FIG. 4A is a top plan view of the first type article accommodation unit shown in FIG. 3, showing of an internal configuration thereof, and FIG. 4B is a cross sectional view of a container main body;

FIG. 5 illustrates an internal configuration of the second article accommodation unit shown in FIG. 3 and includes a schematic and vertical cross sectional view of a container main body and an enlarged view of a main part thereof; and

FIGS. 6A and 6B are perspective views of an external appearance of an article supply device set according to an embodiment of the present invention, wherein FIG. 6A shows an example of an article supply device set and FIG. 6B shows a combination of first article supply devices and second article supply devices, which is different from that shown in FIG. 6B.

### DETAILED DESCRIPTION

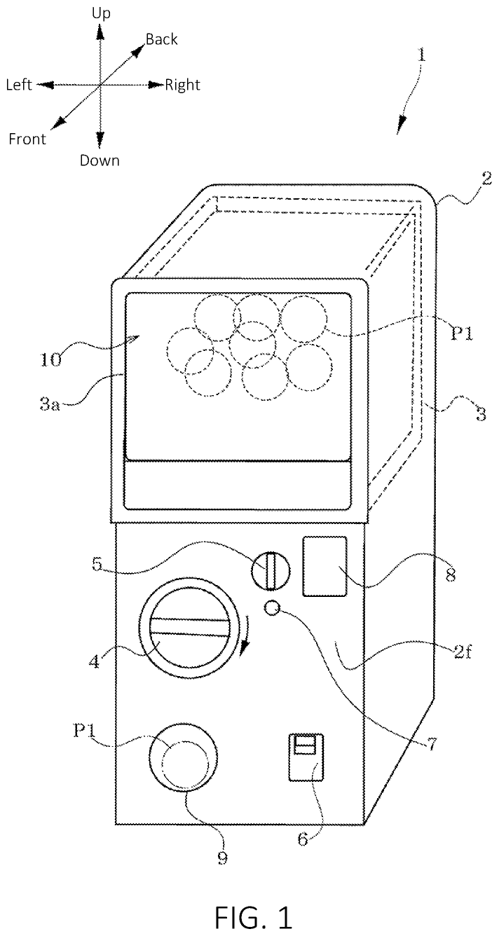

A description will now be given, referring to embodiments thereof. While the claims are not limited to such embodiments, an appreciation of various aspects of the invention is best gained through a discussion of various examples thereof. An article supply device and an article supply device set according to embodiments will be explained below referring to figures. The orientation (directions) set forth below in the explanation, is based on case where the article supply device is viewed from a front face side thereof (in a direction shown in an arrow in FIG. 1), as a standard position. They are shown as up and down directions (upper side or lower side), left and right directions (right side or left side), and front and back directions (front side or back side) when the article supply device is viewed from the front face direction, and these directions are shown in the figures.

### <Configuration of Article Supply Device>

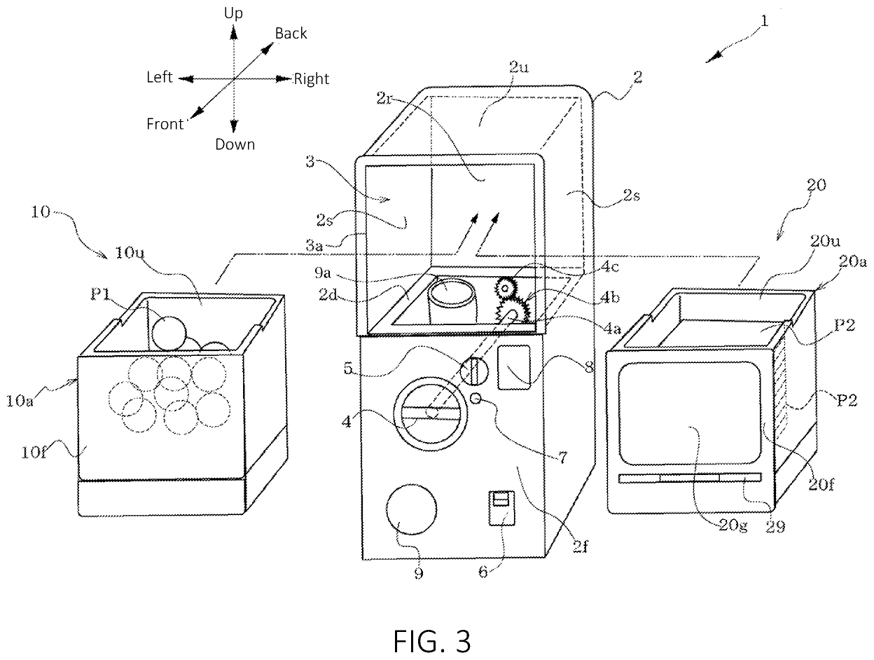

FIG. 1 is a perspective view of an external appearance of an article supply device 1 according to an embodiment, which is capable of supplying a first type article P1. The article supply device 1 can supply (provide) the first type articles P1, each of which is a capsule-shaped, and spherically shaped, in response to insertion of consideration. As shown in FIG. 1, the article supply device 1 has a main body 2 in a box shape surrounded by six faces in front, back, left, right, up and down directions, and various operation portions are provided on a front face 2f thereof. On the front face 2f, for example, an insert port 5 capable of receiving consideration for the first type article P1, a first supply port 9 from which the first type article is discharged, an operation portion 4 capable of supplying the first type article P to the first supply port 9 by a rotational operation, a return port 6 for returning cash as needed, a cash return button 7, and a display portion 8 etc. In addition, a large and rectangular shape opening 3a is formed on an upper side region of the front face 2f, when viewed from the front face side (refer to FIG. 3). A first type article accommodation unit 10 capable of supplying the first type article P1 is detachably attached to an attachment unit 3 provided inside the opening 3a.

Each of these parts will be described below. The operation portion 4 is an operation member which is configured so as to be rotatable in, for example, a clockwise direction (a direction shown by an arrow in the figure) on condition of payment of consideration. The first type article P1 is supplied to the first supply port 9 when a user rotates the operation portion 4 after dropping consideration.

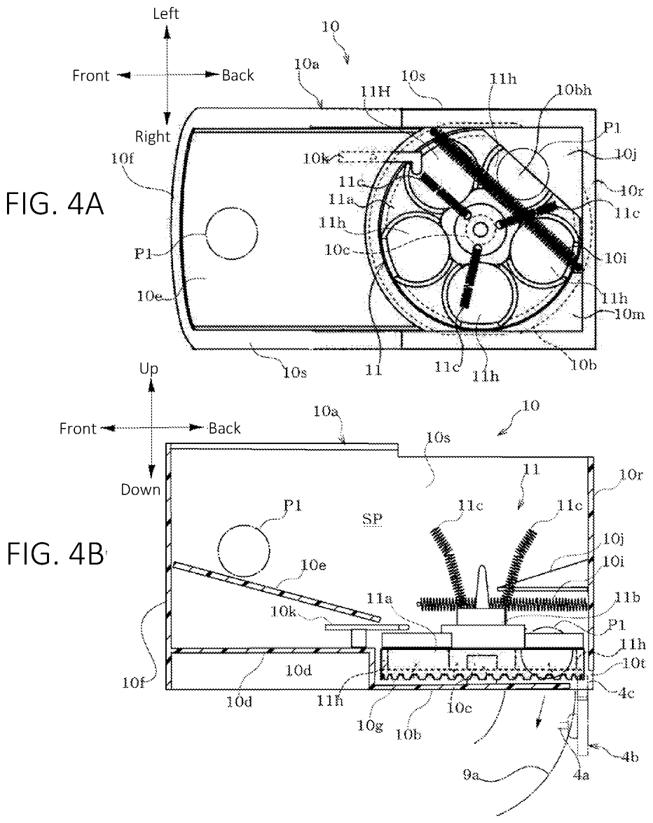

The insert port 5 has a slit shape opening, which is formed in a depressed portion thereof and is capable of inserting coins therein. This insert port 5 can be switched between a cash insertion accepting state and a cash insertion unaccepting state by controlling internal mechanism. For example, a detection mechanism 10k (refer to FIG. 4) which detects the presence of accommodated first type article P1 is provided therein, and the insert port 5 is closed so that no coin may not be accepted, when the detection mechanism 10k does not detect the presence of the first type article P1. By this configuration, it is possible to prevent coins from being inserted by mistake when there is no first type article P1. In addition, the return port 6 is configured to return an inserted coin(s) in response to an operation of the cash return button 7 so that the returned coins can be taken out from the device.

The display portion 8 is provided as needed, and for example, the existence or nonexistence of the first type article P1 can be displayed. For example, when the above-described detection mechanism 10k detects the existence or nonexistence of the first type article P1, such display may be performed in accordance with the detection result.

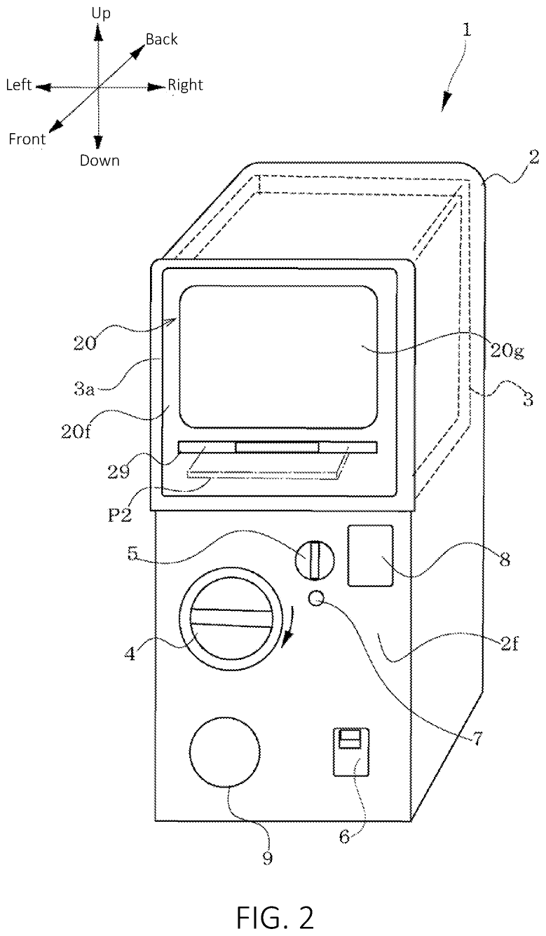

FIG. 2 is a perspective view of an external appearance of an article supply device 1 according to an embodiment, which is capable of supplying a second type article P2. The article supply device 1 shown in FIG. 2, has a basic configuration which is the same as the configuration shown in FIG. 1 but there is a difference therebetween in one aspect. They are different from each other in that a second type article accommodation unit 20 accommodating a second type article P2 which is different from the first type article P1 is attached thereto, in place of the first type article accommodation unit 10 accommodating the first type article P1 shown in FIG. 1. The second type articles P2 exemplified herein, are relatively thin plates or sheet shaped items, such as sheet shaped printed matter, a card, a file, colored paper, a thin case and the like, and can be sent out by a turning force of a roller described later and can be accommodated in a laminated state in the second type article accommodation unit 20.

The second type article P2 is supplied through a mechanism described later by an operation performed to the operation portion 4, and the second type article P2 is supplied to the second supply port 29 provided in a lower portion of a front wall portion 20f of the second type article accommodation unit 20. The operation portion 4 is operated in a same way either in a state where the first type article accommodation unit 10 is attached to the attachment unit 3 or in a state where the second type article accommodation unit 20 is attached to the attachment unit 3. Thus, in the article supply device shown in FIG. 2, the articles to be supplied and the article supply position thereof are different from those shown in FIG. 1, but the main body 2 of the article supply device 1 shown in FIG. 2 is the same configuration shown in FIG. 1.

FIG. 3 is a schematic perspective view of the article supply device shown in FIGS. 1 and 2 in a state where the first type article accommodation unit 10 and the second type article accommodation unit 20 are detached from the main body 2. As shown in FIG. 3, the first type article accommodation unit 10 and the second type article accommodation unit 20 occupy large part of an upper side of the article supply device 1 and are respectively formed in a box shape. In addition, the first type article accommodation unit 10 and the second type article accommodation unit 20 are configured to respectively have openings 10u and 20u, each of which is open on an upper side thereof, wherein the shape and the size thereof are the same as or similar to each other. That is, they are configured so as to be attachable to the same attachment unit 3, but portions which do not interfere with functions thereof and attachment thereto may be different from each other, and external appearances of them are approximately the same as each other.

The attachment unit 3 is surrounded by left and right side walls 2s, a back wall 2r, an upper wall 2u and a bottom wall 2d having an opening if needed, and forms a space in a box shape, which is open on a front side thereof as an opening 3a. Therefore, when the first type article accommodation unit 10 or the second type article accommodation unit 20 is attached to the attachment unit 3, the accommodation unit is attached to the attachment unit 3 by sliding the accommodation unit toward the back side of the main body 2 from the opening 3a. On the other hand, when the accommodation unit is pulled out from the attachment unit 3, the accommodation unit is detached by sliding and moving it toward the front side thereof (a near side) so as to be pulled out. The opening 3a is completely closed by attaching either the first type article accommodation unit 10 or the second type article accommodation unit 20 to the attachment unit 3 (refer to FIGS. 1 and 2). The first type articles P1 and the second type articles P2 can be respectively replenished from the openings 10u and 20u with ease in a state where the first type article accommodation unit 10 or the second type article accommodation unit 20 is pulled out toward the near side of the main body 2 from the attachment unit 3, as show in FIG. 3.

A communicating portion 9a for supplying the first type article P1 from the first type article accommodation unit 10 to the first supply port 9 is provided on a bottom wall 2d side of the attachment unit 3. In addition, a gear mechanism 4b, which includes a gear 4c located at a top part thereof and which is exposed a little toward an upper side from the bottom wall 2d, is provided on a bottom wall 2d side. The gear mechanism 4b is configured so as to be rotatable by a drive axis 4a connected to the operation portion 4. The gear 4c located at the top part is connected to a rotation mechanism for driving the first supply portion 11 for the first type article accommodation unit 10 described later and the second supply portion 22 for the second type article accommodation unit 20 described later. In addition, in the figure, the number of the gear mechanisms 4b is one, but the number thereof is not limited to one.

Here, as mentioned above, the first type article accommodation unit 10 is configured so that a plurality of the first type articles P1, each of which is formed in a spherical shape, can be accommodated. The first type articles P1 are accommodated therein in a non-alignment state as shown in FIG. 3. On the other hand, the second type article accommodation unit 20 accommodates the second type articles P2 in a sheet shape, which are laminated in up and down directions, in an alignment state as shown in FIG. 3.

In the second type article accommodation unit 20, a front wall portion 20f, which is a front face on a front side of the container body 20a, is comprised of a light non-transmitting member. The constituent material of the front wall portion 20f itself may be composed of a light non-transmitting member, or the material of the front wall portion 20f may be composed of a light transmitting member but a light non-transmitting member such as an article image portion 20g, may be formed on a surface thereof, so that the front wall portion 20f may be substantially light non-transmissive. By this configuration, the second type articles P2 may not be viewed from the outside. As such, even though the second type articles to be supplied are not viewed, since an image of the second type article P2 or an image relating thereto is depicted on the article image portion 20g, the second type articles P2 to be supplied can be clearly shown so that the second type article supplied from the second supply port 29, which is provided below the article image portion 20g, can be effectively shown and a performance regarding supply of the second type article P2 from the second supply port 29, which is provided right below the article image portion 20g, can be made.

Material of the container body 10a of the first type article accommodation unit 10 is not limited. For example, it may be composed of plastic. At least part of a side wall of the container body 10a, for example, a front wall 10f, which is a front face on the front side thereof, is composed of a light transmitting member so that the first type articles accommodated thereinside can be viewed.

<Configuration of First Type Article Accommodation Unit 10>

FIG. 4A is a top plan view of the first type article accommodation unit 10 shown in FIG. 3, showing an internal configuration thereof, and FIG. 4B is a cross sectional view of the container body. As shown in FIGS. 4A and 4B, the first type article accommodation unit 10 includes the container body 10a having an external appearance in a rectangular shape with slightly longer sides in the front and back directions. The first type article accommodation unit is surrounded by a front wall portion 10f, a back wall portion 10r, left and right side wall portions 10s and a bottom wall portion 10d, and is opened on an upper side thereof. And, the first supply portion 11 has a function for supplying the first article P1, and the first supply portion 11 is rotatably provided on an accommodation concave portion 10b in an approximately round shape, which is provided on the bottom wall portion 10d. In a planar view of FIG. 4A, a cylindrical main body 11a of the first supply portion 11, which is a first rotation portion formed in a round shape, for example, is supported and rotatably provided at a vertical axis portion 10c.

For example, a plurality of article holding holes 11h, for example five holes (refer to FIG. 4A), are formed at equal intervals in a circumferential direction in the main body 11a of the first supply portion 11. In addition, a face gear type annular gear portion 10g is formed along an outer circumferential edge of a lower end face of the main body 11a. In addition, for example, a projection 11b which projects upward is provided at a rotation center on an upper face side of the main body 11a, wherein an agitating portions 11c, for example springs, are provided on an upper face of the projection 11b. An article passing port 10bh, through which a first type article P1 can fall down into the communication portion 9a of the main body 2, is formed in the accommodation concave portion 10b. That is, the first type article P1 falls down in the communication portion 9a of the main body 2 through the article passing port 10bh in a state where the first type article accommodation unit 10 is attached to the main body 2. As shown in FIG. 4B, part of the gear portion 10g is exposed from the bottom opening 10t formed in the accommodation concave portion 10b.

In addition, in the first type article accommodation unit 10, a first inclined part 10e, which forms a bottom face of the accommodation space SP for the first type articles P1, is provided on a front side with respect to the accommodation concave portion 10b, thereby guiding the first type articles P1 toward a side of the first supply portion 11. In addition, a second inclined part 10m, which is inclined toward the first supply portion 11, is formed at a corner of a back side of the accommodation concave portion 10b (a right lower side in FIG. 4A). Further, a first regulating member 10i, which is a spring, and a second regulating member 10j which is an inclined plate, are provided adjacent to and on an upper side of the article communication port 10bh, in order to regulate the positions of the first articles P1, so that the first articles P1 located on an upper side with respect to the article communication port 10bh may not move (downward) toward the article communication portion 10bh.

Further, a lever shaped detection mechanism 10k, which is brought into contact with a first type article P1 held by one of the article holding holes 11h and is swung thereby, is provided on a lower side with respect to the first inclined part 10e. As described above, it is possible to close the coin insert port 5 and/or to display existence or non-existence of the first type articles P1 on the display portion 8 based on a detection of the first type article P1 performed by this detection mechanism 10k.

In the first supply portion 11, the gear portion 10g engages with the gear 4c provided on a side of the main body 2 in a state where the first type article accommodation unit 10 is attached to the main body 2. Consequently, the first supply portion 11 is rotationally driven by the operation portion 4 which becomes operable by an insertion of coins. When the first type article P1 held by one of the article holding holes 11h comes to the article communication port 10bh, the first type article P1 falls down into the communication port 9a with a falling movement and is supplied to the first supply port 9. Further, in the supply of the first article P1 by the first supply portion 11, one of the first type articles P1 which fell down into the article holding hole 11h by chance is sent out, that is, the first type article P1 is randomly selected and supplied.

<Configuration of the Second Type Article Accommodation Unit 20>

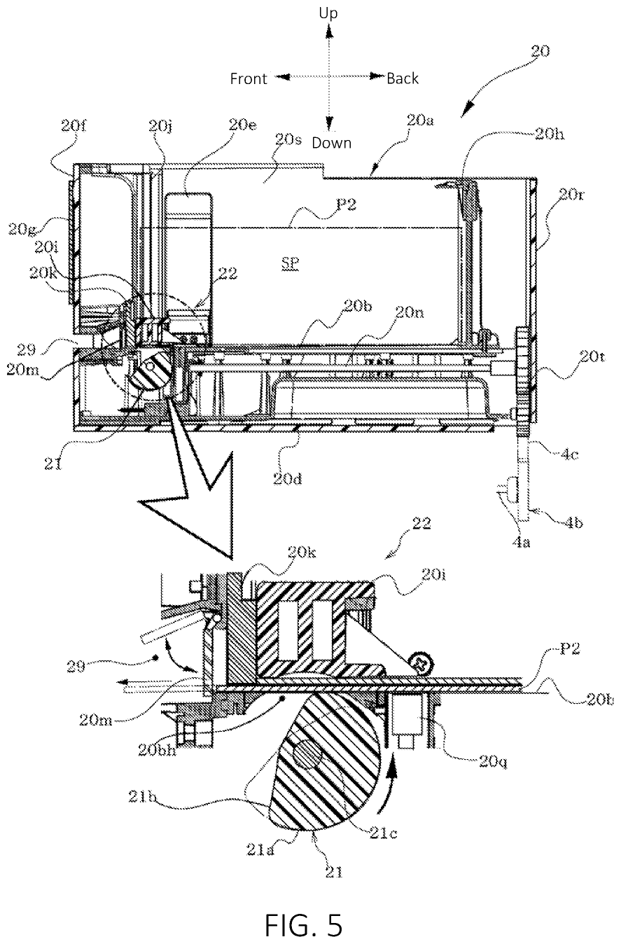

FIG. 5 illustrates an internal configuration of the second article accommodation unit 20 shown in FIG. 3, and includes a schematic and vertical cross sectional view thereof taken along front and back directions, and an enlarged view of a main part thereof. As shown in FIG. 5, a container body 20a of the second type article accommodation unit 20 is configured so as to be in a rectangular shape with slightly longer sides in the front and back directions as in the first type article accommodation unit 10. The container main body 20a in a box shape comprises a front wall portion 20f, which is a front face of a front side thereof, a back wall portion 20r, which is a back face of a back side thereof, side walls 20s, which are left and right side faces thereof, and a bottom wall portion 20d, which is a bottom face on a bottom side thereof, and is open on an upper side thereof, wherein an inner accommodation space SP in a box shape is formed as a rectangle space. Further, the article placing portion 20b which forms a bottom portion of the accommodation space SP, is configured so as to be flat so that the second type articles P2 may be accommodated in a laminated state. In addition, the article placing portion 20b is arranged at slightly high position, so that a lower space, in which the second supply portion 22 can be arranged, may be formed between the article placing portion 20b and the bottom wall portion 20d of the container main body 20a.

Material of the container main body 20a is not specifically limited, and, for example, may be made of plastic and has a second supply port 29 capable of supplying the second type article on a front face side of the container main body 20a. As described above, the article image portion 20g is disposed on an upper side of the second supply port 29.

Here, a pair of left and right guides 20e, which is arranged on left and right sides near a front side of the space of the accommodation space SP is provided, and a rear guide 20h is provided at a position near a back side of the space so as to rise from the article placing portion 20b. In addition, a depressing portion 20i capable of pressing down the second type articles P2 from an upper side thereof in a state where the second type articles P2 are accommodated and laminated, is provided on a front side with respect to the left and right guides 20e. The depressing portion 20i is a rectangular parallelepiped weight, which has long sides in left and right directions, and is held so as to be capable of being moved up and down along a rail shaped holding portion 20j having a recess formed on a front side with respect to the left and right guides 20e.

Further, the left and right guides 20e are movably provided in left and right directions on the article placing portion 20b, and the rear guide 20h is movably provided in the front and back directions on the article placing portion 20b. Therefore, it is possible to accommodate the second type articles P2 having different sizes by moving the left and right guides 20e and the rear guide 20h.

A front end guide portion 20k, which engages in transportation of an article, is provided along the depressing portion 20i in a front side with respect to the depressing portion 20i. The front end guide portion 20k is disposed right behind a shutter 20m which is swingable so as to open and close the second supply port 29. The front end guide portion 20k guides the second type article so as to discharge the second type article P2 one by one when the second type article P2 is supplied. The height of the front end guide portion 20k from the article placing portion 20b can be adjusted to conform the thickness of the second type article P2.

A supply roller 21, which is a second rotation portion arranged along the horizontal directions, is positioned below the article placing portion 20b so as to face the depressing portion 20i. As shown in a side view of FIG. 5, the supply roller 21 has a circular arc outer face 21a and a non-circular arc outer face 21b, whose diameter is smaller than that of the circular arc outer face 21a. Therefore, when the supply roller 21 is rotated with respect to the rotation axis 21c, the circular arc outer face 21a is brought into contact with a lower face of the second type article P2, which is pressed down by the depressing portion 20i (refer to an enlarged part in FIG. 5). The second type article P2 is transferred toward a front side by the rotation in the contact state. That is, the circular arc outer face 21a which is slightly projected upward from a placing portion opening 20bh, is brought into contact with the lower face of the second type article P2 positioned at the lowest position, and slides the second type article P2 toward a front side thereof, thereby providing the second type article P2 from the second supply port 29. In this way, the second type articles P2 are supplied in series in a predetermined order from one located at the lowest position among the second type articles P2 accommodated in the article accommodation unit 20, by the second supply portion 22.

Moreover, the supply roller 21 is connected to, for example, a plurality of gear portions 20t provided along with the back wall 20r, a connecting shaft 20n which extends toward a side of the supply roller 21 from the axis portion of one of the gear portions 20t, and a gear (not shown) provided on a front end side of the connecting shaft 20n. In addition, the lowermost gear among the gear portions 20t is provided so as to correspond to the gear 4c provided on a side of the main body 2. Therefore, the lowermost gear of the gear portion 20t and the gear 4c of the gear mechanism 4b side engage with each other for making connection in a state where the second type article accommodation unit 20 is attached to the main body 2. As a result, the supply roller 21 is rotated and driven by the operation portion 4 which has become operable by insertion of coin(s). Further, the mechanism for detecting existence or non-existence of the accommodated second type articles P2 may be configured by, for example, a detection mechanism 20q which can be brought into contact with the second type article P2 from a lower side of the article placing portion 20b.

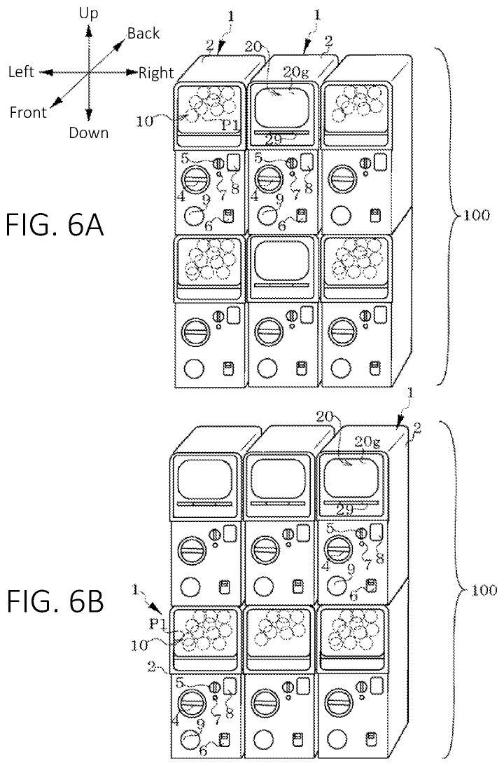

FIGS. 6A and 6B are perspective views of an external appearance of an article supply device set according to an embodiment of the present invention. The article supply device set 100 shown in FIG. 6A comprises, for example, four first article supply devices 1 and two second article supply devices 1. The first article supply devices 1 can supply first type articles P1 in a spherical shape, and the second article supply devices 1 can supply a second type article P2 in a sheet shape. In this case, first type article accommodation units 10, each of which accommodates first type articles P1, are respectively attached to the first article supply devices 1, and second type article accommodation units 20, each of which accommodates second type articles P2, are respectively attached to the second article supply devices 1. The first article supply device(s) 1 and the second article supply device(s) 1 are different from each other in an appearance viewed from a front side therefor, but the main body 2 of each of the first and second article supply devices 1 has the same configuration, that is, only the attached first and second type article accommodation units 10 and 20 are different from each other.

As shown in FIG. 6A, the article supply device set 100 is configured by a combination of the four devices for supplying the first type article P1 and the two devices for supplying the second type article P2. After the article supply device set 100 is installed, the number of devices for supplying the first type articles P1 and that for supplying the second type articles P2 (combination thereof) may be changed. For example, in the initial set configuration, a ratio of the devices for supplying the first type article P1 and that for supplying the second type article P2 is set so as to be 2:1. However, there is case where a sales performance which is originally expected is different from that in actual circumstances where the sales of the second type articles P2 is higher than that of the first type articles P1. As shown in FIG. 6B, it is possible to very easily deal with such case, by attaching the second type article accommodation unit(s) 20 thereto in place of the first type article accommodation unit(s) 10. That is, the article supply device set 100 can be modified in response to change in sales performance etc., depending on the time and situation.

As described above, in the article supply device according to the present embodiment, while the first type article accommodation unit 10 which can accommodate the first type articles P1 or the second type article accommodation unit 20 which can accommodate the second type articles P2, can be attached to the main body 2, the first type article accommodation unit 10 or the second type article accommodation unit 20 is equipped with the first supply portion 11 or the second supply portion 22 for each type of articles, so that the same main body 2 can be used as a device for supplying different articles.

In the article supply device 1 according to the present embodiment, the opening 3a is closed by attaching either the first type article accommodation unit 10 or the second type article accommodation unit 20 to the attachment unit 3, which communicates with the opening 3a formed in the main body 2, so that it is possible to use the article supply device without providing a feeling of strangeness in the external appearance even if either the first type article accommodation unit 10 or the second type article accommodation unit 20 is attached to the attachment unit 3.

In the article supply device 1 according to the present embodiment, while the first supply potion 11 supplies the first type article P1 to the first supply port 9 with a falling movement, the second supply potion 22 supplies the second type article P2 to the second supply port 29 with a horizontal movement, so that two paths may be easily secured due to the difference of moving directions in the supply paths (falling down and horizontal) and the same main body 2 can be used for them. In addition, since the second type articles P2 are in a sheet shape, there is a possibility that the second type article would be damaged if it is provided with a falling movement. Therefore, it is possible to prevent such damage of the second type article by supplying it with the horizontal movement.

Further, in the article supply device 1 according to the present embodiment, the front wall portion 20f of the second type article accommodation unit 20, which forms a front side of the main body 2, is configured so that an article image portion 20g on which the second type article or an image relating thereto is drawn may be arranged. By the configuration, a performance for supplying the second type article P2 from the second supply port 29 provided right under the article image portion 20g can be made.

Still further, in the article supply device 1 according to the present embodiment, in a state where the first type article accommodation unit 10 or the second type article accommodation unit 20 is attached to the attachment unit 3, the operation portion 4 is configured to interlock with the operation mechanism (the main body 11a and the supply roller 21) in case of both the article accommodation units 10 and 20, so that a common operation is possible in either case

Moreover, in the article supply device 1 according to the present embodiment, the first type article accommodation unit 10 or the second type article accommodation unit 20 is configured so as to have opening on an upper side of the accommodation space SP, so that the first type articles P1 or the second type articles P2 can be easily replenished by pulling out the article accommodation unit toward a front side thereof from the attachment unit 3 of the main body 2.

In the article supply device set 100 according to the present embodiment, a plurality of the first article supply devices 1, which supply the first type articles P1 and a plurality of the second article supply devices 2 which supply the second type articles P2, are arranged. Since all the main bodies 2 have the same configuration so that either the first type article accommodation unit 10 or the second type article accommodation unit 20 may be attached to the first and second article supply devices 1, the number of first type article accommodation unit 10 attached thereto and the number of the second type article accommodation units 20 attached thereto can be easily changed so that the configuration of the article supply device set may be very easily changed according to the need.

The embodiments of the present invention are described above. The present invention may be changed within the technical idea thereof. For example, in the above-described embodiments, the shape of the first type article accommodation unit 10 and that of the second type article accommodation unit 20 are not limited to those shown in the figures.

As explained above, the present specification discloses the features set forth below.

(1) An article supply device comprises a main body; a first type article accommodation unit or a second type article accommodation unit; an attachment unit provided in the main body and capable of replacing the first type article accommodation unit and the second type article accommodation unit with each other to be attached thereto; a first supply unit which supplies a first type article accommodated in the first type article accommodation unit; a first supply port formed in the main body; and a second supply unit which includes a second supply port and supplies a second type article accommodated in the second type article accommodation unit, wherein the first supply unit supplies the first type article to the first supply port in a state where the first type article accommodation unit is attached to the attachment unit, and the second supply unit supplies the second type article to the second supply port in a state where the second type article accommodation unit is attached to the attachment unit.

(2) In the article supply device according to (1), an opening is formed in the main body, and the opening is closed by attaching either the first type article accommodation unit or the second type article accommodation unit.

(3) In the article supply device according to either (1) or (2), the first supply unit supplies the first type article to the first supply port with a falling movement, and the second supply unit supplies the second type article to the second supply unit with a horizontal movement.

(4) In the article supply device according to (3), the second supply unit supplies the second type article to the second supply port with a slide movement.

(5) In the article supply device according to any one of (1)-(4), the first type article accommodation unit is capable of accommodating the first type articles in a spherical shape and the second type article accommodation unit is capable of accommodating the second type articles in a sheet shape.

(6) In the article supply device according to any one of (1)-(5), the first type article accommodation unit is capable of accommodating the first type articles in a non-alignment state, and the second type article accommodation unit is capable of accommodating the second type articles in an alignment state.

(7) In the article supply device according to any one of (1)-(6), the first supply unit is configured so as to randomly select and supply the first type article accommodated in the first type article accommodation unit, and the second supply unit is configured so as to non-randomly select and supply the second type article accommodated in the second type article accommodation unit.

(8) In the article supply device according to (6), the second supply unit supplies in order one from among the second type articles, which is located at the lowest position in the second type article accommodation unit.

(9) In the article supply device according to any one of (1)-(8), the second type article accommodation unit is configured so that an article image portion can be arranged on a front face which forms a front face portion of the main body, and the second supply port is formed right under the article image portion.

(10) In the article supply device according to any one of (1)-(9), the first type article accommodation unit is formed in a box shape and at least part of a side wall of the first type article accommodation unit is composed of a light transmitting member, and the second type article accommodation unit is formed in a box shape and at least part of a side wall of the second type article accommodation unit is composed of a light non-transmitting member.

(11) In the article supply device according to any one of (1)-(10), an external appearance of the first type article accommodation unit and that of the second type article accommodation unit are the same as each other or similar to each other.

(12) In the article supply device according to any one of (1)-(11), the main body has an operation portion capable of performing an operation on condition that a payment of consideration is made, and a commo operation can be performed by the operation portion either in a state where the first type article accommodation unit is attached to the attachment unit or in a state where the second type article accommodation unit is attached to the attachment unit.

(13) In the article supply device according to any one of (1)-(12), the first type accommodation unit includes a first rotation portion and the second type article accommodation unit includes a second rotation portion, and the first rotation portion is configured to be rotatable about an axis in a vertical direction and the second rotation portion is configured to be rotatable about an axis in a horizontal direction.

(14) In the article supply device according to (13), the main body has an operation portion capable of performing an operation on condition that a payment of consideration is made, the first rotation portion and the second rotation portion are interlocked with the operation of the operation portion and rotated.

(15) In the article supply device according to any one of (1)-(14), the first type article accommodation unit and the second type article accommodation unit are respectively configured so that the first type articles or the second type articles can be replenished by pulling out the first type article accommodation unit or the second type article accommodation unit from the attachment unit of the main body toward a front side of the main body.

(16) An article supply device set made up of a plurality of article supply devices, comprises a first article supply device capable of supplying first type articles in a spherical shape, to which a first type article accommodation unit accommodating the first type article is attached, and a second article supply device capable of supplying second type articles in a sheet shape, to which a second type article accommodation unit accommodating the second type article is attached, wherein the first article supply device and the second article supply device are configured to have the same configuration so that either the first type article supply device or the second type article supply device can be attached to the main body thereof.

Although only some exemplary embodiments have been described in detail above, those skilled in the art will readily appreciate that many modifications are possible in the exemplary embodiments without materially departing from the novel teachings and advantages. Accordingly, all such modifications are intended to be included within the scope.

1. An article supply device comprising
a main body;
a first type article accommodation unit or a second type article accommodation unit;
an attachment unit provided in the main body and capable of replacing the first type article accommodation unit and the second type article accommodation unit, to be attach thereto, with each other;
a first supply unit which supplies a first type article accommodated in the first type article accommodation unit;
a first supply port formed in the main body; and
a second supply unit which includes a second supply port and supplies a second type article accommodated in the second type article accommodation unit,
wherein the first supply unit supplies the first type article to the first supply port in a state where the first type article accommodation unit is attached to the attachment unit, and the second supply unit supplies the second type article to the second supply port in a state where the second type article accommodation unit is attached to the attachment unit.

2. The article supply device according to claim 1, wherein an opening is formed in the main body, and the opening is closed by attaching either the first type article accommodation unit or the second type article accommodation unit to the attachment unit.

3. The article supply device according to claim 2, wherein the first supply unit supplies the first type article to the first supply port with a falling movement, and the second supply unit supplies the second type article to the second supply unit with a horizontal movement.

4. The article supply device according to claim 3, wherein the second supply unit supplies the second type article to the second supply port with slide movement.

5. The article supply device according to claim 4, wherein the first type article accommodation unit is capable of accommodating the first type article in a spherical shape and the second type article accommodation unit is capable of accommodating the second type article in a sheet shape.

6. The article supply device according to claim 5, the first type article accommodation unit is capable of accommodating the first type article in a non-alignment state, and the second type article accommodation unit is capable of accommodating the second type article in an alignment state.

7. The article supply device according to claim 6, wherein the first supply unit is configured so as to randomly select and supply the first type article accommodated in the first type article accommodation unit, and the second supply unit is configured so as to non-randomly select and supply the second type article accommodated in the second type article accommodation unit.

8. The article supply device according to claim 6, wherein the second supply unit supplies in order one, which is located at the lowest position in the second type article accommodation unit, from among the second type articles.

9. The article supply device according to claim 1, wherein the second type article accommodation unit is configured so that an article image portion can be arranged on a front face which forms a front face portion of the main body, and the second supply port is formed right under the article image portion.

10. The article supply device according to claim 9, wherein the first type article accommodation unit is formed in a box shape and at least part of a side wall of the first type article accommodation unit is composed of a light transmitting member, and the second type article accommodation unit is formed in a box shape, and at least part of a side wall of the second type article accommodation unit is composed of a light non-transmitting member.

11. The article supply device according to claim 1, wherein an external appearance of the first type article accommodation unit and that of the second type article accommodation unit are the same as each other or similar to each other.

12. The article supply device according to claim 1, wherein the main body has an operation portion capable of performing an operation on condition that a payment of consideration is made, and a common operation can be performed by the operation portion either in a state where the first type article accommodation unit is attached to the attachment unit or in a state where the second type article accommodation unit is attached to the attachment unit.

13. The article supply device according to claim 12, wherein the first type accommodation unit includes a first rotation portion and the second type article accommodation unit includes a second rotation portion, and the first rotation portion is configured to be rotatable about an axis in a vertical direction and the second rotation portion is configured to be rotatable about an axis in a horizontal direction.

14. The article supply device according to claim 13, wherein the first rotation portion and the second rotation portion are interlocked with the operation of the operation portion and rotated.

15. The article supply device according to claim 1, wherein the first type article accommodation unit and the second type article accommodation unit are respectively configured so that the first type article or the second type article can be replenished by pulling out the first type article accommodation unit or the second type article accommodation unit from the attachment unit toward a front side of the main body.

16. An article supply device set made up of a plurality of article supply devices, comprising:
a first article supply device capable of supplying a first type article in a spherical shape, to which a first type article accommodation unit accommodating the first type article is attached, and
a second article supply device capable of supplying a second type article in a sheet shape, to which a second type article accommodation unit accommodating the second type article is attached,
wherein the first article supply device and the second article supply device are respectively configured so that either the first type article supply device or the second type article supply device can be attached to the main body thereof.
